(19) United States
(12) Patent Application Publication
(10) Pub. No.: US 2025/0012383 A1
(43) Pub. Date: Jan. 9, 2025

(54) TUBULAR LINER, METHOD OF FABRICATION AND USE THEREOF

(71) Applicant: SANEXEN ENVIRONMENTAL SERVICES INC., Brossard (CA)

(72) Inventors: Sylvain MORISSETTE, Sherbrooke (CA); Olivier BOUX, Sherbrooke (CA); Joël HÉRAUD, Sherbrooke (CA)

(21) Appl. No.: 18/687,588

(22) PCT Filed: Aug. 26, 2022
(86) PCT No.: PCT/CA2022/051293

§ 371 Date: Feb. 28, 2024

Related U.S. Application Data
(60) Provisional application No. 63/260,949, filed on Sep. 7, 2021.

(51) Int. Cl. F16L 11/02; B32B 1/08; B32B 5/02; B32B 37/12; B32B 37/24; B32B 38/10; D03D 3/02; D03D 15/283; D03D 15/30; D03D 15/41; D03D 15/56; F16L 11/10

(52) U.S. Cl. CPC F16L 11/02; B32B 1/08; B32B 5/022; B32B 37/12; B32B 37/24; B32B 38/10; D03D 3/02; D03D 15/283; D03D 15/30; D03D 15/41; D03D 15/56; F16L 11/10; B32B 2262/0276; B32B 2262/0292; B32B 2262/148; B32B 2262/16; B32B 2305/188; B32B 2307/51; B32B 2307/546; B32B 2307/7265; B32B 2367/00; B32B 2375/00; B32B 2597/00; D10B 2331/04; D10B 2331/10; D10B 2505/00

(57) ABSTRACT

A method for fabricating a liner for a tubular hose, comprising selecting a combination of functional filaments and filling filaments, the functional filaments being elastic filaments, and combining the functional filaments and the filling filaments, in a ratio selected according to a target radial expansion and compression of the liner, under a selected twisting tension and with a selected twist number; into filler yarns; selecting warp yarns according to a target rigidity in a longitudinal direction of the liner; twisting together a number of the filler yarns into filler threads and the warp yarns into warp threads; and weaving the liner around the hose by interlacing the filler threads and the warp threads.

### FIELD OF THE INVENTION

The present invention relates to tubular liners. More specifically, the present invention is concerned with a liner, a method of fabrication and use thereof.

### BACKGROUND OF THE INVENTION

Hoses are flexible pipes usually of a circular cross section, used to carry fluids from one location to another. They may be straight hoses or coil hoses. The size, pressure rating, weight, length and chemical material composition are selected depending on specific applications, environments, chemical compatibility and target performances.

Fire hoses typically comprise jackets having inner and outer surfaces comprising warp yarns trapped between crisscrossing woven filler yarns, referred to also as weft yarns. The warp yarns are typically in spun polyester, filament polyester or filament nylon, and the crisscrossing woven filler yarns (weft yarns) in filament polyester for example, wound in a tight spiral around the circumference of the hose in such a way to provide strength to resist the internal water pressure.

There is still a need in the art for tubular liners.

### SUMMARY OF THE INVENTION

More specifically, in accordance with the present invention, there is provided a method for fabricating a liner for a tubular hose, comprising selecting filler yarns and warp yarns, wherein selecting the filler yarns comprises selecting a combination of functional filaments and filling filaments, the functional filaments being elastic filaments, and combining the functional filaments and the filling filaments, in a ratio selected according to a target radial expansion and compression of the liner, under a selected twisting tension and with a selected twist number; into filler yarns; selecting the warp yarns comprises selecting yarns according to a target rigidity in a longitudinal direction of the liner; twisting together a number of the filler yarns, for example between 2 and about 30 yarns, into filler threads; twisting together the warp yarns into warp threads; and positioning the hose in a weaving machine and weaving the liner around the hose by interlacing the filler threads and the warp threads; thereby sheathing the hose with the liner.

There is further provided an external liner for a flexible hose, the liner being woven from filler threads and warp threads, wherein the filler threads are twisted from filler yarns, the filler yarns being selected as a combination of functional filaments and filling filaments, wherein the functional filaments are elastic filaments selected for abrasion resistance, the filling filaments are selected for binding property; the functional filaments and the filling filaments being combined, in a ratio selected according to a target radial expansion and compression of the liner, into filler yarns, under a selected under a selected twisting tension and with a selected twist number; and a number of filler yarns, being twisted together into filler threads; wherein the warp threads are twisted from warp yarns, the warp yarns being selected according to a target rigidity in a longitudinal direction of the liner; and twisted together into warp threads; and wherein the filler threads and the warp threads are woven into the liner in a weaving machine, the flexible hose being positioned in a center of the weaving in such a way that the liner is woven around the flexible hose, thus sheathing the hose once the hose is retrieved from the weaving machine.

There is further provided a flexible hose, comprising an external liner woven from filler threads and warp threads, wherein the filler threads are twisted from filler yarns, the filler yarns being selected as a combination of functional filaments and filling filaments, wherein the functional filaments are elastic filaments selected for abrasion resistance, the filling filaments are selected for binding property; the functional filaments and the filling filaments being combined, in a ratio selected according to a target radial expansion and compression of the liner, into filler yarns, under a selected under a selected twisting tension and with a selected twist number; and a number of filler yarns, being twisted together into filler threads; and wherein the warp threads are twisted from warp yarns, the warp yarns being selected according to a target rigidity in a longitudinal direction of the liner; and twisted together into warp threads; and wherein the filler threads and the warp threads are woven into the liner in a weaving machine, the flexible hose being positioned in a center of the weaving in such a way that the liner is woven around the flexible hose, thus sheathing the hose once the hose is retrieved from the weaving machine.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows elongation of a filler yarn for a liner according to an embodiment of an aspect of the present disclosure;

FIG. 2 shows a section of a sheathed hose according to an embodiment of an aspect of the present disclosure;

FIG. 3 shows fabric weight values of a liner according to an embodiment of an aspect of the present disclosure;

FIG. 4 shows the tensile strength of a fabric of a liner according to an embodiment of an aspect of the present disclosure;

FIG. 5 shows weaving of a liner according to an embodiment of an aspect of the present disclosure;

FIG. 6A shows load as a function of elongation in tensile tests of a flat fabric along the filler direction on a sample of 1 po length of fabric of a liner according to an embodiment of an aspect of the present disclosure;

FIG. 6B shows elongation of the fabric at specific load levels on a sample of 1 po length of fabric of a liner according to an embodiment of an aspect of the present disclosure;

FIG. 6C shows load as a function of elongation in tensile tests of a flat fabric along the filler direction on a sample of 1 po length of fabric of a liner according to an embodiment of an aspect of the present disclosure;

FIG. 6D shows elongation of the fabric at specific load levels on a sample of 1 po length of fabric of a liner according to an embodiment of an aspect of the present disclosure;

FIG. 7 shows a patch laminated onto a liner according to an embodiment of an aspect of the present disclosure;

FIG. 8 indicates the thickness of a coextrusion of glue and thermoplastic urethane (TPU) resin for the patch;

FIG. 9 shows adhesion of a patch on a liner as evaluated under a 180-degree peel test, according to an embodiment of an aspect of the present disclosure;

FIG. 10A shows thermoplastic urethane (TPU) material used for the a patch according to an embodiment of an aspect of the present disclosure;

FIG. 10B shows laminating the patch of FIG. 10A on the fabric of the liner according to an embodiment of an aspect of the present disclosure;

FIG. 10C shows dead weight applied on patch upon cooling after laminating as per FIG. 10B;

FIG. 10D shows cutting apertures in the patch and the fabric of a liner according to an embodiment of an aspect of the present disclosure;

FIG. 10E shows a cutting tool for cutting apertures in the patch and the a liner according to an embodiment of an aspect of the present disclosure;

FIG. 11A show a liner with a patch, sheathing a hose, according to an embodiment of an aspect of the present disclosure;

FIG. 11B shows the patch of FIG. 11A;

FIG. 11C shows a strap connected to the hose of FIG. 11A;

FIG. 12 shows a hose, sheathed with a liner with patches, mounted to a pump in a well according to an embodiment of an aspect of the present disclosure;

FIG. 13 shows connection of a hose to a coupling according to an embodiment of an aspect of the present disclosure;

FIG. 14 shows abrasion of a liner after 12,000 friction cycles in an abrasion test according to an embodiment of an aspect of the present disclosure;

FIG. 15 shows a sheathed hose with connecting straps, according to an embodiment of an aspect of the present disclosure;

FIG. 16A shows full openings in the patch and the liner, according to an embodiment of an aspect of the present disclosure; and

FIG. 16B shows ear-like openings in the patch and the liner; according to an embodiment of an aspect of the present disclosure.

### DESCRIPTION OF ILLUSTRATIVE EMBODIMENTS

The present invention is illustrated in further details by the following non-limiting examples, in the case of a flexible hose for installation and operation in a pumping well.

A liner according to an embodiment of an aspect of the present disclosure is made of a woven fabric comprising woven warp yarns and wefts yarns, the wefts yarns being also referred to herein as filler yarns. The yarns may be assembled from filaments by throwing or cable twisting for example, and they may be texturized.

A method according to an embodiment of an aspect of the present disclosure comprises selecting the filler yarns (wefts) as a combination of functional filaments selected for their abrasion resistance and filling filaments, the functional filaments being selected as elastic filaments, such as thermoplastic polyurethane elastomer, polyester based thermoplastic polyurethane (TPU) filaments; and textile filaments, and the filling filaments being selected as glass filaments, carbon filaments or polyester filaments in relation to binding properties with a patch as will be discussed hereinbelow.

For example, in an embodiment of an aspect of the present disclosure, the method comprises selecting Spandex™ filaments as functional filaments and polyester filaments as filling filaments, and combining the Spandex™ filaments with the polyester filaments in a ratio in a range between about 1 and about 10% by weight, into filler yarns, depending on a target radial expansion and compression of a target end liner to be woven, under a twisting tension selected in a range between about 0.4 N and about. 0.7 N, and with a twist number in a range between about 0.5 and about 2 TPI (twist per inch). The method may comprise texturizing the polyester filaments (filling filaments) according to a target resistance to abrasion of the end liner by the external environment under installation and/or operation depending on the applications, in the pumping well for example.

The method then comprises twisting together a number of yarns thus assembled from filaments, for example between 2 and about 30 yarns. The compression and elastic properties of the filler threads, assembled from filler yarns (weft yarns), is controlled in relation to the hose diameter, which determined the liner diameter, in such a way that the diameter of the end liner tightly matches the hose diameter both without restricting or pinching the hose when the hose is under pressure, and without slack when the hose pressure varies and decreases, by selecting the ratio of the functional filaments in the filler threads. In experiments, the filler yarns (wefts) are formed of 9,600 deniers pre-textured polyester filaments and 5% Spandex™ for example.

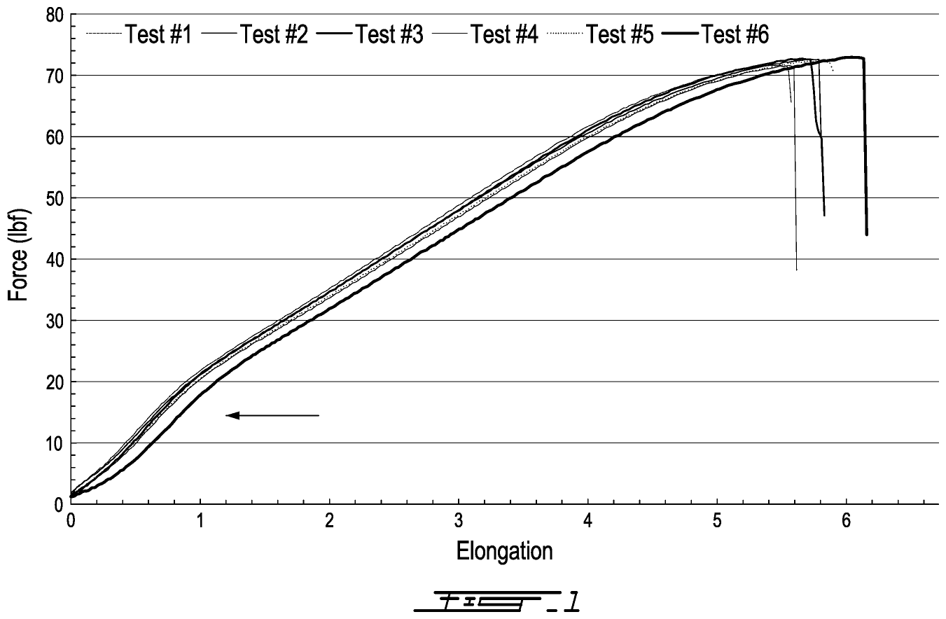

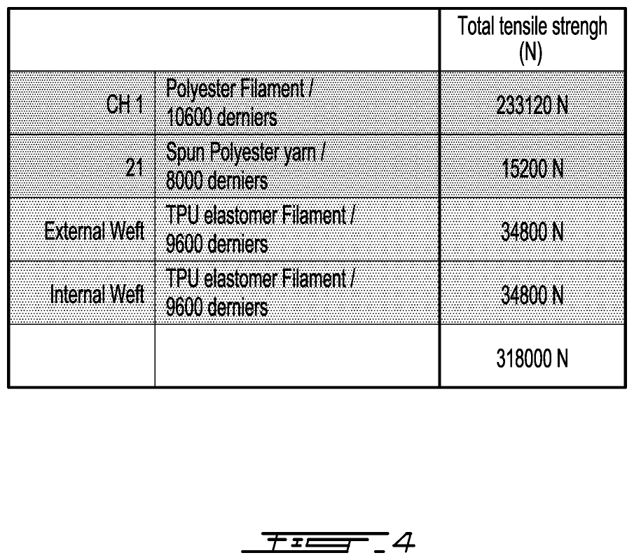

In the present example, with a polyester ratio of the filler yarns of 95% for 5% Spandex™, the tensile force of the assembled filler yarn (filler thread) is about 380 g (that is, about 3.7 N), upon winding in a winding machine, the thread tension force on the filler bobbin (see FIG. 5) is between about 400 g and about 500 g (that is, between about 3.9 N and about 4.9 N) of tension, and the elongation at break of the filler thread is between about 25 and about 35% (FIG. 1).

Warp yarns are twisted together into warp threads, selected for bonding with a patch as will be described hereinbelow; in the present example, a warp yarn of spun polyester is used, in combination with a high tenacity yarn of continuous polyester filaments selected to provide rigidity in the longitudinal direction of the liner.

The method comprises positioning the hose in the center of a weaving machine and weaving a fabric around the hose by interlacing the filler (wefts) threads and warp threads (see FIG. 5). In the present example, the weaving diameter is 170 mm and the tension of the filler thread is between about 450 g about 600 g (that is, between about 4.4 N and about 5.9 N). The diameter at rest of the weaving machine being 144 mm in the present example, the diameter of the tubular fabric when released from the weaving machine decreases by 26 mm (15%), as a result from the compressibility of the filler thread.

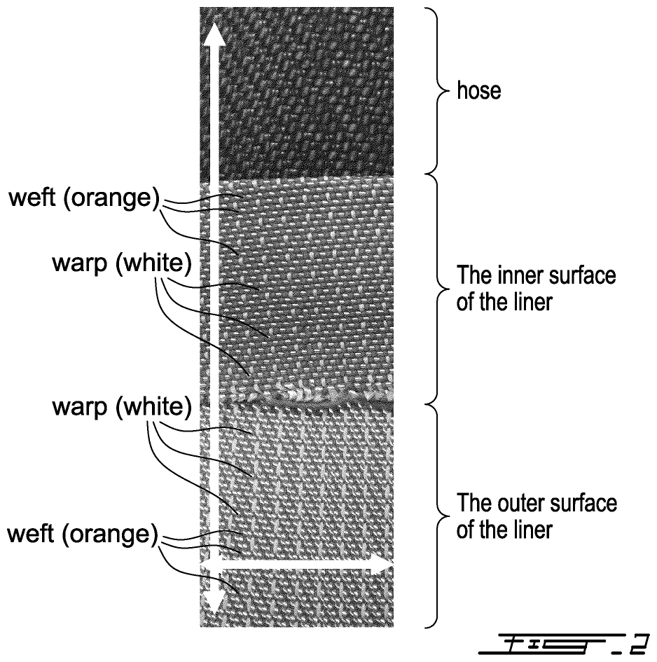

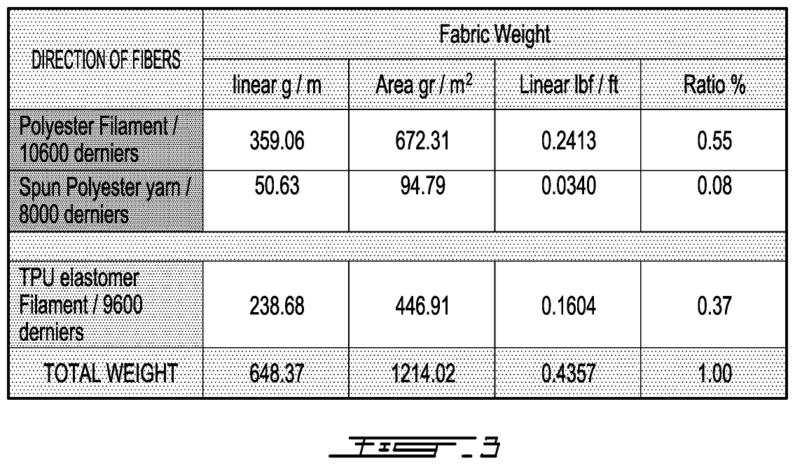

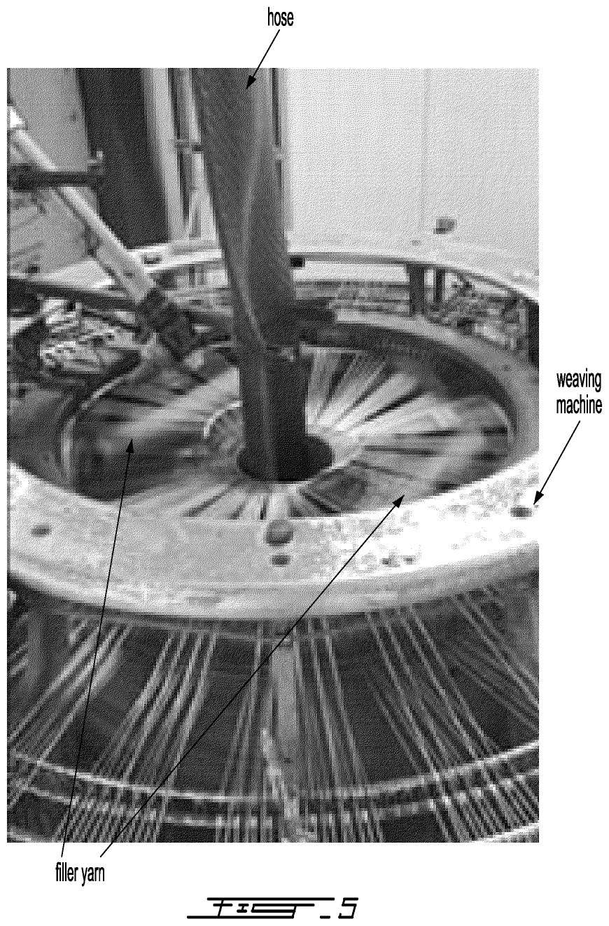

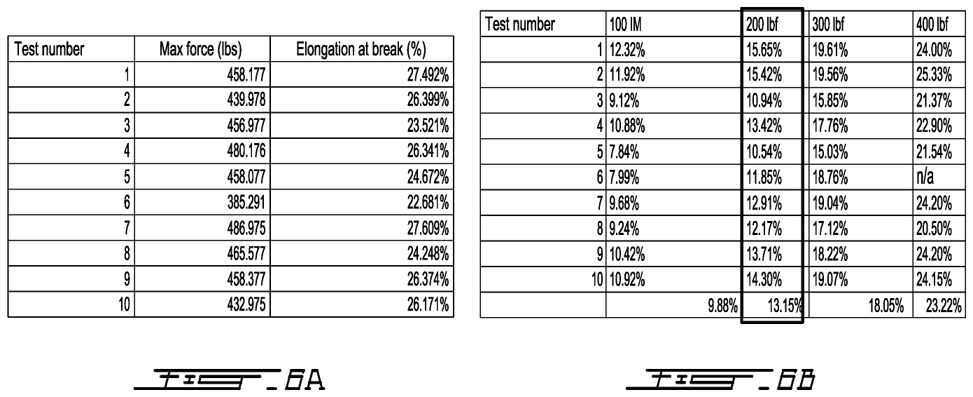

In the present example as illustrated for example in FIG. 2, the resulting fabric weave is a 2×1 twill—2 types of warp (filler) threads, 276 threads of 10,600 deniers high tenacity (HT) polyester filaments +5,800 deniers polyester spun threads for bonding as will be described hereinbelow for a patch, yielding warps of 15.8 ends per inch (EPI). The filler thread, textured polyester and Spandex™, amounts for 36% of the aerial weight, defined as the mass per unit area of fabric, of the fabric. The composition of the filler, in particular the functional filaments, controls the elasticity of the fabric in the filler direction. FIGS. 3 and 4 show ratios and directions of the threads of the fabric. FIG. 6 shows the elasticity of the resulting fabric along the filler direction per 1 inch of fabric (ppi=pick per inch). Its elongation at break (about 25 and 35% elongation) allows the liner to tightly compress the hose under pressure without restricting the diameter of the hose.

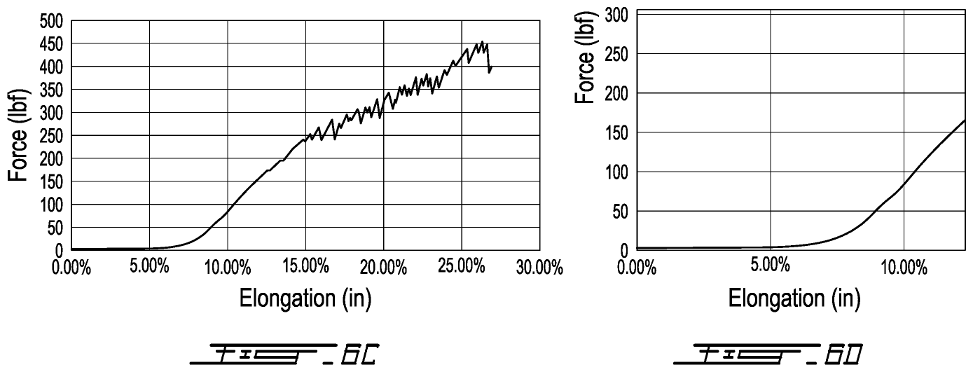

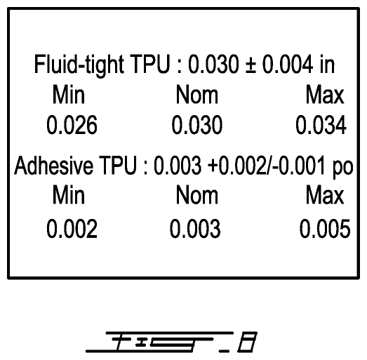

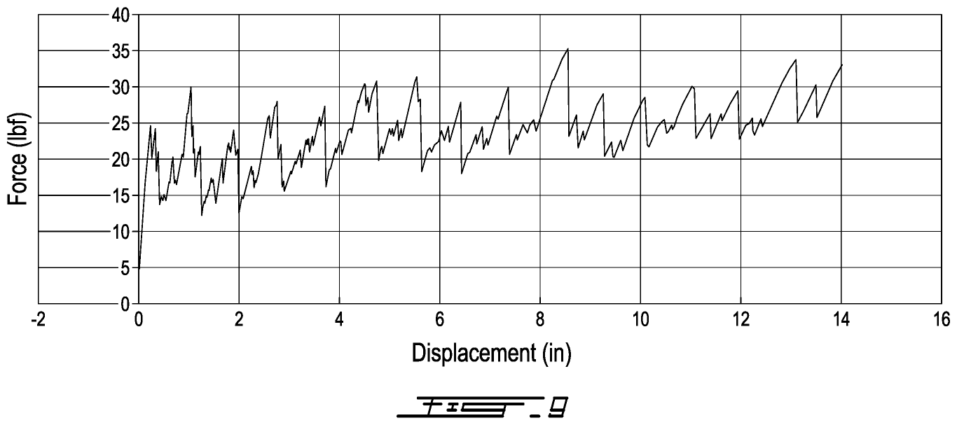

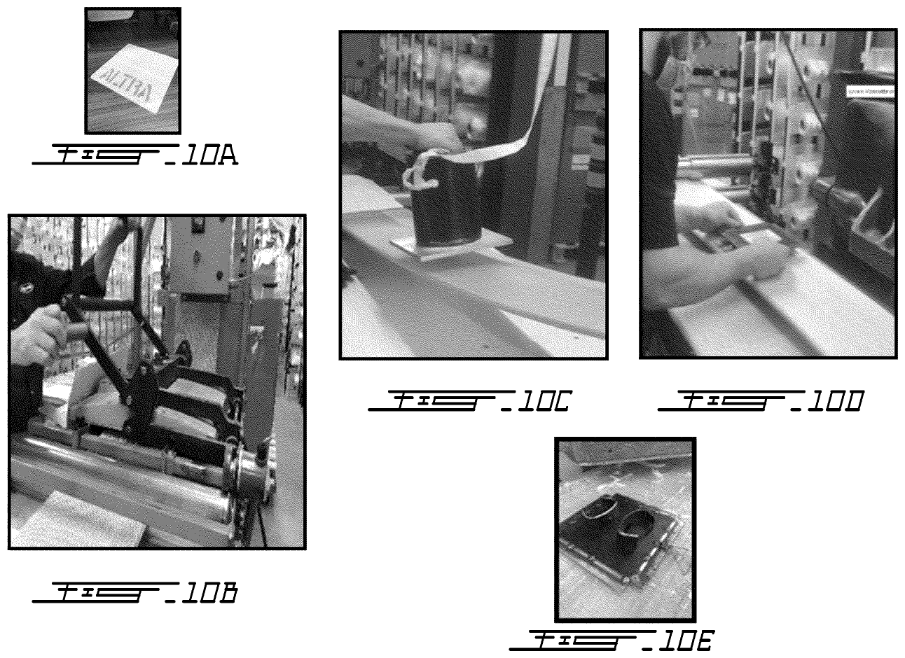

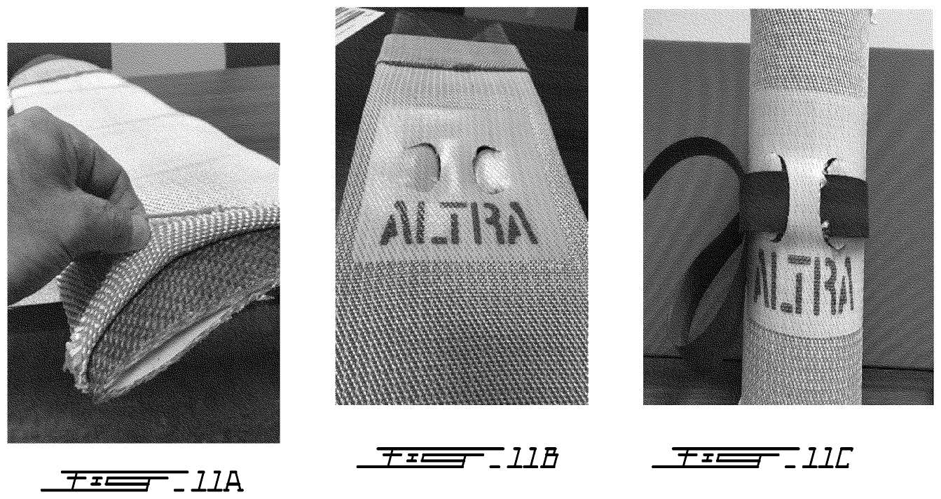

According to an aspect of the present disclosure, a method comprises fabricating a patch, as will now be described in relation to FIGS. 7-12 for example. The method comprises coextruding a fluid tight layer and an adhesive layer, the adhesive layer selected for binding reinforcement of the fabric of the liner when cutting through the patch and the liner (see FIG. 10B), and upon use as an anchorage of attachment rings 20 made by the cutting through the patch and the liner (ear-like openings in the patch and liner are shown in FIGS. 10C, 15B, full openings in the patch and liner are shown in 15A), as will be described hereinbelow. The patch prevents fraying of the liner about the edges of the openings.

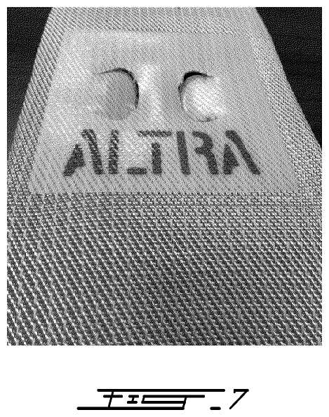

FIGS. 7 show a 7.5×7.5 inches patch made of coextruded thermoplastic polyurethanes (TPU) (FIG. 10A). FIG. 8 indicates the thickness of the fluid tight layer and of the adhesive layer, also referred to as glue, of the patch.

The method further comprises laminating the patch on the liner, under a pressure selected to prevent delamination, for example in the presently described experiments, at 400° F. under a pressure of at least 20 psi, for example of about 40 psi for 1 minute; the spun polyester in the warps of the liner and the adhesive layer of the patch ensuring adhesion of the patch to the liner (FIGS. 8, 9, 10B).

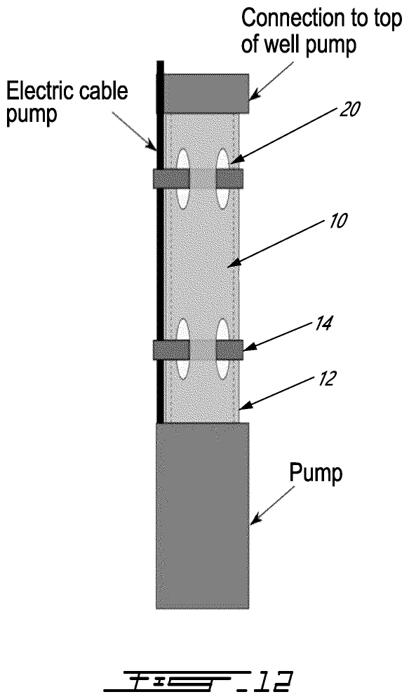

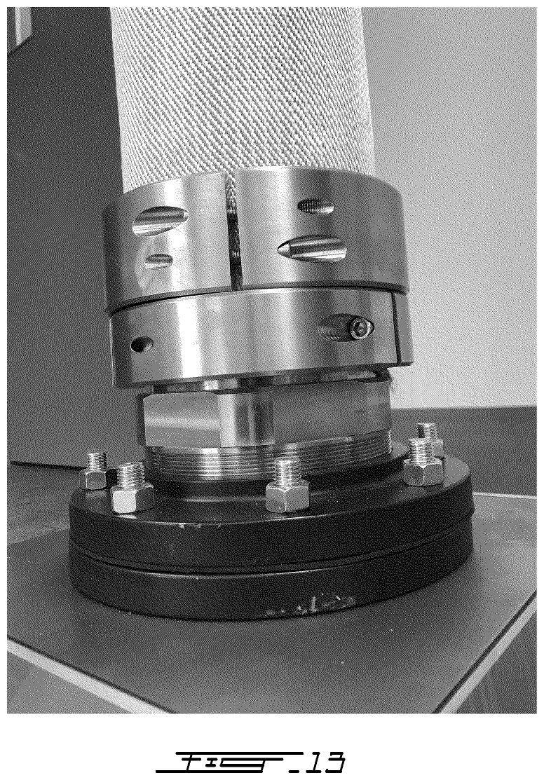

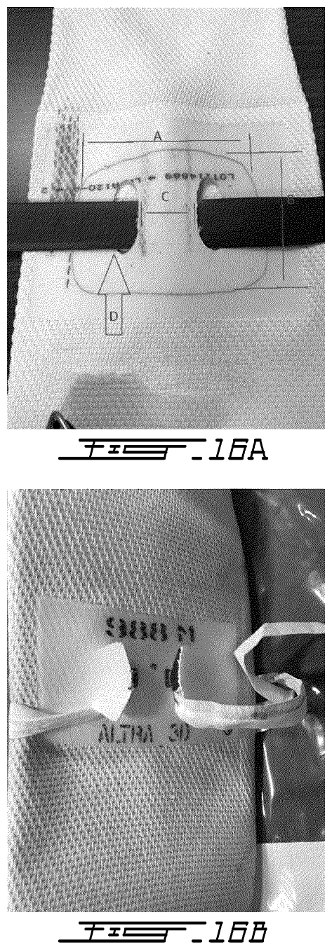

After cooling while still maintaining the pressure (FIG. 10 C), openings are cut out through the patch 12 and the liner 10 beneath (FIGS. 10D, 10E), using a die cut for example. For a precise cutting and preventing cutting through the hose, an insert, such as a lamination plate may, be positioned between the liner and the hose (FIG. 10C) The openings form the attachment rings 20 for insertion of a connecting element, such as a connecting strap 14 for example, between the hose and the liner (FIG. 7, FIGS. 11, 12, 15). The patch holds the threads of the liner together, thus ensuring a resistant attachment area under load. FIGS. 10C, 11 and 15B show ear-like openings, while FIGS. 15 and 16A show full openings.

FIG. 9 shows the adhesion force of the patch on the liner, measured as the displacement under a peel test by initiating delamination of a band of width 1 ½ inch of the patch and pulling at 180°; showing oscillations with maxima between about 23 and about 35 lbf, corresponding to the onset of propagation of the delamination, and minima between about 12 and about 25 lbf, corresponding to termination of the propagation of the delamination, for an average adhesion force of about 20 lbf.

In resistance tests under a load of 200 lbf applied to the attachment rings 20, no breakage of the rings or rupture of threads of the liner 10 was observed, and the assembly was evaluated to support 2,400 lbf before failure at the breaking point.

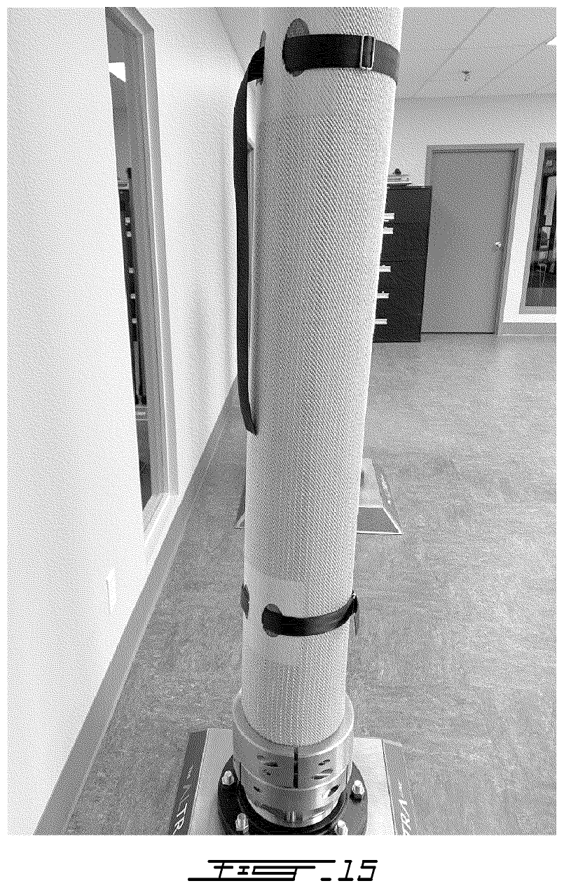

Abrasion tests were conducted by submitting the edges of the liner to friction cycles, with the liner deflated in a lay-flat position when, in absence of pressure, the hose is deflated, in order to simulate a real situation occurring when the liner is submitted to friction with the walls of the well as the hose is put under pressure and therefor inflates within the well. FIG. 14 shows abrasion of the liner after 12,000 friction cycles, the abraded zone being the orange line in the fold of the right hand side of the image. The liner thus proves to efficiently protect the hose against mechanical abrasion.

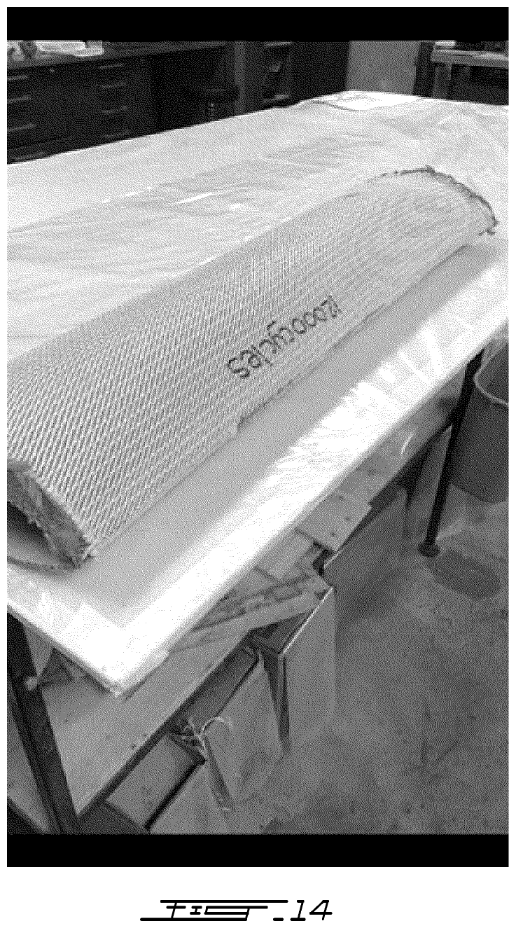

In tests performed to assess damages of the hose resulting in leak under operating pressure (425 psi for example), a 6 inch diameter hose, sheathed with a liner provided with attachment rings as described hereinabove for connection to couplings, is submitted to a controlled increase in internal pressure until a burst pressure of 1,060 psi leading to the hose burst and thus leakage. As shown in FIG. 13, even though, when two collars connect the hose (right handside in FIG. 13) on the couplings (left hand side in FIG. 13), a clearance, of about 0.125 in or more, is maintained in between the two collars, the coupling assembly is evaluated fluid tight up to a pressure of at least 1,000 psi.

There is thus presented herein an external liner for a flexible hose, and a method of fabrication thereof. The liner may be circularly woven, or formed from a flat fabric, or formed otherwise such as by knitting for example. The method comprises selecting functional filaments in the radial direction of the liner in such a way that the liner adjusts to the variations in diameter of the hose and the movement of the hose without restriction of the hose upon operation.

The liner may comprise attachment rings reinforced by a patch locally reinforcing the wall of the lined hose from the outside surface of the hose, allowing connection of external parts to the hose as required in specific applications. The attachment rings allow connection to a hanging pump power cable in a mining well for example (FIG. 12), or external parts to be connected to the hose, depending on the application, or connecting the hose to components such as for hanging the hose in between sites, such as between two buildings for example, while maintaining the properties and performance of the hose and allowing operation of the hose regardless of its orientation, in a vertical, horizontal, suspended or other positions in which the hose is operated in a given application.

Moreover, the liner protects the hose from the outer environment, for example from abrasion. The liner may be used as a sacrificial layer.

Thus, there is provided a method and a system for fabricating a multi-functional liner and connections on the hose, allowing ease of installation of the hose on site and target resistance under operation of the hose, by selecting and controlling the elasticity, the resistance, and the contact of the liner with the hose while maintaining the integrity of the hose.

The method comprises weaving a liner, assembling the liner and a tubular member controlling that the liner is smaller in diameter than the tubular member by selecting the compressibility force and the maximum extension of the liner through selecting the weft thread in the fabric of the liner. The liner acts as a compression sheath on the tubular member, and may provide attachment points to the tubular member through anchor points, while maintaining the integrity of the tubular member. As described hereinabove, the anchor points may be provided using a patch laminated on the liner by, in a continuous process: locating the patch on the liner, controlling heat transfer selectively to the patch by using a lamination plate of the geometry of the patch, controlling uniform surface adhesion of the patch on the liner, maintaining the patch once laminated on the liner during cooling, and controlling precise cutting out of openings through the patch and the liner while maintaining the integrity of the tubular member. The liner is a compressible protection for the tubular member.

A patch may thus be secured to the liner, the warp of the liner being selected for optimized adhesion between the patch to the liner. The patch holds the threads of the fabric together, thus ensuring a resistant attachment zone on the tubular member, attachment points being shown in experiments described hereinabove to withstand 2,400 lbf before breaking for example The patch provides binding reinforcement when cutting through the liner. and upon use as an anchorage for attachment rings, the warps of the liner ensuring adhesion of the patch to the liner. A connector may thus be inserted between the hose and the liner through the attachment rings.

The present method and system comprise fabricating a protection for a tubular member, that further allows external parts to be connected to the tubular member as required depending of the application for the tubular member without altering the properties and performance of the tubular member, ease of installation on site and operation of the tubular member. An outer liner is assembled on the tubular member; the elasticity and resistant structure of the fabric for the liner, woven from filler yarns and warps, are selected and controlled to ensure contact with the tubular member without altering the tubular member and without movement at the interface with the outer surface of the tubular member. A patch is positioned on the outer liner, the composition and geometry of the patch being selected and controlled to accommodate attachment points on the tubular member providing a target resistance under load.

The present disclosure presents a method and a system for fabricating an outer liner that acts as a compression sleeve on the tubular member. The outer liner is tubularly woven, with a diameter selected and controlled in relation to the diameter of the tubular member, about the tubular member. The parameters of the liner, including the compressibility force and the maximum extension thereof, are selected and controlled by selecting the weft thread of the liner. Warps are selected according to a target compressibility of the liner in the circumference of the tubular member.

The present disclosure presents a method and a system for providing attachment points on the tubular member. The attachment points are fabricated without damaging the tubular member, by laminating a patch on the outer liner and cutting out openings through both the patch and liner, in a continuously process. The patch geometry and location on the liner, the distance between the openings and the geometry of the openings, and the accurate cutting out of the openings through the patch and liner, are selected and controlled depending on the diameter of the tubular member and target applications. For lamination of the patch on the liner, selective heat transfer to the patch, uniform surface adhesion of the patch against the liner and lamination stabilization are controlled. Patch lamination on the liner and openings cutting out are performed in a step-by-step process using a step driving system in a continuous process. Lamination of the patch on the liner may be performed using circular drums, instead of a lamination plate as described herein.

The scope of the claims should not be limited by the embodiments set forth in the examples but should be given the broadest interpretation consistent with the description as a whole.

1. (canceled)

2. The method of claim 8, wherein the functional filaments are selected among thermoplastic polyurethane (TPU); elastomer filaments, polyester based thermoplastic polyurethane (TPU), and textile filaments; the filling filaments are selected among glass filaments, carbon filaments and polyester filaments; and the warp yarns comprise spun polyester filaments and continuous polyester filaments.

3. The method of claim 8, further comprising texturizing the filling filaments according to a target resistance to abrasion of the liner.

4. The method of claim 8, wherein said twisting together a number of the filler yarns comprises twisting together at least 2 filler yarns.

5. The method of claim 8, wherein said twisting together a number of the filler yarns comprises twisting together between 2 and 30 filler yarns.

6. The method of claim 8, wherein said twisting together a number of the filler yarns comprises twisting together between 2 and 30 filler yarns, with a twist number between 0.5 and 2 twist per inch (TPI).

7. The method of claim 8, further comprising selecting an adhesive material and a fluid tight material and coextruding a fluid tight layer and an adhesive layer into a patch; and laminating the patch on the liner on a surface thereof opposite the hose.

8. A method for fabricating a liner for a tubular hose, comprising:
selecting filler yarns and warp yarns, wherein said selecting the filler yarns comprises selecting a combination of functional filaments and filling filaments, the functional filaments being elastic filaments, and combining the functional filaments and the filling filaments, in a ratio selected according to a target radial expansion and compression of the liner, under a selected twisting tension and with a selected twist number; into filler yarns; said selecting the warp yarns comprises selecting yarns according to a target rigidity in a longitudinal direction of the liner;
twisting together a number of the filler yarns, between 2 and about 30 yarns, into filler threads;
twisting together the warp yarns into warp threads; and
positioning the hose in a weaving machine and weaving the liner around the hose by interlacing the filler threads and the warp threads;
thereby sheathing the hose with the liner;
the method further comprising selecting an adhesive material and a fluid tight material and coextruding a fluid tight layer and an adhesive layer into a patch; laminating the patch on the liner on a surface thereof opposite the hose under a lamination pressure selected to prevent delamination; cooling; and cutting out openings through the patch and the liner, thereby forming attachment rings to the hose.

9. The method of claim 8,
wherein said cutting out the openings comprises inserting a plate between the hose and the liner and using a die-cut; thereby forming attachment rings to the hose.

10. A method for fabricating a liner for a tubular hose, comprising:
selecting filler yarns and warp yarns, wherein said selecting the filler yarns comprises selecting a combination of functional filaments and filling filaments, the functional filaments being elastic filaments, and combining the functional filaments and the filling filaments, in a ratio selected according to a target radial expansion and compression of the liner, under a selected twisting tension and with a selected twist number; into filler yarns; said selecting the warp yarns comprises selecting yarns according to a target rigidity in a longitudinal direction of the liner;
twisting together a number of the filler yarns, between 2 and about 30 yarns, into filler threads;
twisting together the warp yarns into warp threads; and
positioning the hose in a weaving machine and weaving the liner around the hose by interlacing the filler threads and the warp threads;
thereby sheathing the hose with the liner;
wherein the functional filaments are Spandex™ filaments, the filling filaments are one of i): polyester filaments and ii) texturized polyester filaments, the Spandex™ filaments and the polyester filaments are combined in a ratio in a range between 1 and 10% of the Spandex™ filaments by weight of the polyester filaments, under a twisting tension selected in a range between 0.4 N and 0.7 N, and with a twist number in a range between 0.5 and 2 twist per inch (TPI); and the warp yarns are yarns of spun polyester filaments and of continuous polyester filaments.

11. (canceled)

12. (canceled)

13. The method of claim 17, wherein the functional filaments are selected among thermoplastic polyurethane (TPU) elastomer filaments polyester based polyester based thermoplastic polyurethane (TPU) and textile filaments; the filling filaments are selected among glass filaments, carbon filaments and polyester filaments; and the warp yarns comprise spun polyester filaments and continuous polyester filaments.

14. (canceled)

15. The method of claim 17, wherein the number of filler yarns is comprised in a range between 2 and 30.

16. The method of claim 17, wherein the number of filler yarns is comprised in a range between 2 and 30 with a twist number in a range between 0.5 and 2 twist per inch (TPI).

17. An external liner for a flexible hose, the liner being woven from filler threads and warp threads,
wherein the filler threads are twisted from filler yarns, the filler yarns being selected as a combination of functional filaments and filling filaments, wherein the functional filaments are elastic filaments selected for abrasion resistance, the filling filaments are selected for binding property; the functional filaments and the filling filaments being combined, in a ratio selected according to a target radial expansion and compression of the liner, into filler yarns, under a selected twisting tension and with a selected twist number; and a number of filler yarns, being twisted together into filler threads;
wherein the warp threads are twisted from warp yarns, the warp yarns being selected according to a target rigidity in a longitudinal direction of the liner; and twisted together into warp threads; and
wherein the filler threads and the warp threads are woven into the liner in a weaving machine, the flexible hose being positioned in a center of the weaving in such a way that the liner is woven around the flexible hose, thus sheathing the hose once the hose is retrieved from the weaving machine; and wherein the functional filaments are Spandex™ filaments, the filling filaments are one of: i) polyester filaments and texturized polyester filaments, the Spandex™ filaments and the polyester filaments are combined in a ratio in a range between 1 and 10% by weight of the polyester filaments, under a twisting tension selected in a range between 0.4 N and 0.7 N, and with a twist number in a range between 0.5 and 2 twist per inch (TPI); and the warp yarns are yarns of spun polyester filaments and of continuous polyester filaments.

18. (canceled)

19. (canceled)

20. An external liner for a flexible hose, the liner being woven from filler threads and warp threads,
wherein the filler threads are twisted from filler yarns, the filler yarns being selected as a combination of functional filaments and filling filaments, wherein the functional filaments are elastic filaments selected for abrasion resistance, the filling filaments are selected for binding property; the functional filaments and the filling filaments being combined, in a ratio selected according to a target radial expansion and compression of the liner, into filler yarns, under a selected twisting tension and with a selected twist number; and a number of filler yarns, being twisted together into filler threads;
wherein the warp threads are twisted from warp yarns, the warp yarns being selected according to a target rigidity in a longitudinal direction of the liner; and twisted together into warp threads; and wherein the filler threads and the warp threads are woven into the liner in a weaving machine, the flexible hose being positioned in a center of the weaving in such a way that the liner is woven around the flexible hose, thus sheathing the hose once the hose is retrieved from the weaving machine; and further comprising a patch on a free surface thereof opposite the hose, openings through the patch and the liner forming attachment rings for insertion of a connecting element between the hose and the liner; wherein said patch is one of: i) laminated on the free surface thereof opposite the hose; and ii) a coextrusion of an adhesive material and a fluid tight material laminated on the free surface of the liner.

21. (canceled)

22. (canceled)

23. The flexible hose of claim 27, wherein the functional filaments are ones of: thermoplastic polyurethane elastomer filaments, polyester based polyester based thermoplastic polyurethane (TPU) filaments and textile filaments; the filling filaments are ones of: glass filaments, carbon filaments and polyester filaments; and the warp yarns comprise spun polyester filaments and continuous polyester filaments.

24. (canceled)

25. The flexible hose of claim 27, wherein the number of filler yarns is comprised in a range between 2 and 30.

26. The flexible hose of claim 27, wherein the number of filler yarns is comprised in a range between 2 and 30 with a twist number between 0.5 and 2 twist per inch (TPI).

27. A flexible hose, comprising an external liner woven from filler threads and warp threads,
wherein the filler threads are twisted from filler yarns, the filler yarns being selected as a combination of functional filaments and filling filaments, wherein the functional filaments are elastic filaments selected for abrasion resistance, the filling filaments are selected for binding property; the functional filaments and the filling filaments being combined, in a ratio selected according to a target radial expansion and compression of the liner, into filler yarns, under a selected twisting tension and with a selected twist number; and a number of filler yarns, being twisted together into filler threads; and
wherein the warp threads are twisted from warp yarns, the warp yarns being selected according to a target rigidity in a longitudinal direction of the liner; and twisted together into warp threads; and wherein the filler threads and the warp threads are woven into the liner in a weaving machine, the flexible hose being positioned in a center of the weaving in such a way that the liner is woven around the flexible hose, thus sheathing the hose once the hose is retrieved from the weaving machine wherein the functional filaments are Spandex™ filaments, the filling filaments are one of: i) polyester filaments and ii) texturized polyester filaments, the Spandex™ filaments and the polyester filaments are combined in a ratio in a range between 1 and 10% by weight of the polyester filaments, under a twisting tension selected in a range between 0.4 N and 0.7 N, and with a twist number in a range between 0.5 and 2 twist per inch (TPI); and the warp yarns are yarns of spun polyester filaments and of continuous polyester filaments.

28. (canceled)

29. The flexible hose of claim 27, further comprising attachment rings for connecting an external element to the hose.

30. A flexible hose, comprising an external liner woven from filler threads and warp threads,
wherein the filler threads are twisted from filler yarns, the filler yarns being selected as a combination of functional filaments and filling filaments, wherein the functional filaments are elastic filaments selected for abrasion resistance, the filling filaments are selected for binding property; the functional filaments and the filling filaments being combined, in a ratio selected according to a target radial expansion and compression of the liner, into filler yarns, under a selected twisting tension and with a selected twist number; and a number of filler yarns, being twisted together into filler threads; and
wherein the warp threads are twisted from warp yarns, the warp yarns being selected according to a target rigidity in a longitudinal direction of the liner; and twisted together into warp threads; and wherein the filler threads and the warp threads are woven into the liner in a weaving machine, further comprising a patch on a free surface thereof opposite the hose, openings through the patch and the liner forming attachment rings for insertion of a connecting element between the hose and the liner, wherein said patch is one of: i) a patch laminated on the free surface thereof opposite the hose, and ii) a coextrusion of an adhesive material and a fluid tight material laminated on the free surface of the liner.

31. (canceled)
